(19) United States
(12) Patent Application Publication
(10) Pub. No.: US 2026/0064579 A1
(43) Pub. Date: Mar. 5, 2026

(54) METHODS AND SYSTEMS FOR ACCESSING DATA BLOCKS STORED IN NON-VOLATILE MEMORY BY MULTIPLE PROCESSORS OF A MEMORY DEVICE

(71) Applicant: SK Hynix NAND Product Solutions Corp. (dba Solidigm), Rancho Cordova, CA (US)

(72) Inventors: Hermes Alexandre Alcantara Silva Costa, Mission Viejo, CA (US); Steven Williams, Longmont, CO (US)

(21) Appl. No.: 18/767,876

(22) Filed: Jul. 9, 2024

(51) Int. Cl. G06F 12/02

(52) U.S. Cl. CPC G06F 12/0246

(57) ABSTRACT

This application is directed to processing data between a computational storage processor and a non-volatile memory via an internal interface within a memory device. The memory device has a chip, including a first processor and a second processor, and a non-volatile memory storing a first data block set. A method for processing data includes generating a first request for the first data block set by the second processor. The method also includes sending the first request from the second processor to the first processor. The method further includes in response to the first request, extracting the first data block set from the non-volatile memory by the first processor. The method further includes providing, by the first processor, the first data block set to the second processor.

### RELATED APPLICATION

This application is related to U.S. patent application Ser. No. 18/767,846, filed Jul. 9, 2024, titled, “Reserved Memory Space in Computational Storage Devices,” which is incorporated by reference by its entirety.

### TECHNICAL FIELD

This application relates generally to access management in a memory system including, but not limited to, methods, systems, and non-transitory computer-readable media for managing memory accesses by a plurality of processors in a memory system.

### BACKGROUND

Memory is employed in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. The secondary memory stores a larger volume of data than primary memory included in or closely associated with the one or more processors. Examples of the secondary memory include, but are not limited to, hard disk drives (HDDs) and solid-state drives (SSDs). A secondary memory device such as an SSD is connected to a host device (e.g., a computer, a server, etc.) through an external interface (e.g., Nonvolatile Memory Express (NVMe)). The external interface enables the host device to copy blocks of data from a volatile memory of the host device and store data in a non-volatile memory of the SSD. The external interface also enables the host device to later retrieve the stored data by copying blocks of data from the non-volatile memory of the SSD to the volatile memory of the host device. While the host device specializes in data processing, it has to obtain input data from, and store output data onto, the non-volatile memory of the SSD via the external interface, which oftentimes limiting data processing performance of an associated electronic system.

### SUMMARY

Various embodiments of this application are directed to applying an internal interface for loading data from a non-volatile memory for a data processor to facilitate local data processing within a memory device. A memory device that incorporates data processing capabilities is also called a computational storage device, and the associated internal interface is also called a processor-to-processor interface or a command interface in this application. The computational storage device is coupled to a host device (e.g., a local computer, a server). The memory device includes a memory controller subsystem (e.g., including a memory controller) and a non-volatile memory (e.g., a NAND flash), and when configured as a computational storage device, further includes an embedded computational storage subsystem (e.g., including a data processor). The embedded computational storage subsystem executes an operating system and performs data processing inside the computational storage device. In some embodiments, data are extracted from the non-volatile memory of the memory device, and processed locally by the computational storage subsystem within the memory device. In some embodiments, data are generated locally by the computational storage subsystem within the memory device, and stored in the non-volatile memory of the memory device.

In some embodiments, the embedded computational storage subsystem can read data from, and write data to, the non-volatile memory through the internal interface, and data transfer is managed within the memory device. The internal interface bridges the embedded computational storage subsystem and the controller subsystem via a volatile memory within the computational storage device. As such, the embedded computational storage subsystem can freely access data stored in the non-volatile memory via the internal interface and perform complex data processing. Implementations of the internal interface in memory devices offer a pathway to conduct data processing and meet intricate computation demands for various modern technologies (e.g., cloud computing, artificial intelligence, etc.). Application of the internal interface enables data processing to become self-contained within computational storage devices, thereby reducing processing time, physical space, and energy consumption.

In accordance with one aspect of the application, a method of processing data is implemented at an electronic device. The electronic device includes a chip and a non-volatile memory storing a first data block set. The chip includes a first processor and a second processor. The method includes generating a first request for the first data block set by the second processor. The method further includes sending the first request from the second processor to the first processor. The method of further includes in response to the first request, extracting the first data block set from the non-volatile memory by the first processor. The method of further includes providing, by the first processor, the first data block set to the second processor.

In some embodiments, the method of processing data further includes generating, by the second processor, a second request for storing a second data block set in the non-volatile memory. The method further includes sending the second request including the second data block set from the second processor to the first processor. The method further includes in response to the second request and by the first processor, storing the second data block set in the non-volatile memory. The method of further includes providing, by the first processor, a write result to the second processor.

In another aspect of the application, a memory device includes a non-volatile memory for storing a first data block set and a chip coupled to the non-volatile memory. The chip further includes a first processor and a second processor. The memory device is configured to perform any of the methods described in the above embodiments.

In yet another aspect of the application, a memory system includes a host device and a memory device coupled to the host device. The memory device further includes a non-volatile memory and a chip. The non-volatile memory is configured to store a first data block set. The chip is configured to couple to the non-volatile memory and includes a first processor and a second processor. The chip is configured to perform any of the methods described in the above embodiments.

In yet another aspect of the application, a non-transitory computer-readable storage medium stores instructions, which when executed by a memory system cause the memory system to perform any of the methods described in the above embodiments.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device having one or more memory access queues, in accordance with some embodiments.

FIG. 3 is a block diagram of an example computer system that includes a memory system having an internal processing capability, in accordance with some embodiments.

FIG. 4 is a block diagram of an example computer system including a memory system that operates in compliance with a storage access and transport protocol, in accordance with some embodiments.

FIG. 5 is a block diagram of an example electronic system including a processor-to-processor interface for reading data block sets within a memory device, in accordance with some embodiments.

FIG. 6 is a block diagram of another example electronic system including a processor-to-processor interface 540 for writing data block sets in a memory device, in accordance with some embodiments.

FIG. 7 is a schematic diagram of a storage scheme used in circular buffers of a volatile memory, in accordance with some embodiments.

FIG. 8 is a flow diagram of an example method for processing data on a memory device, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

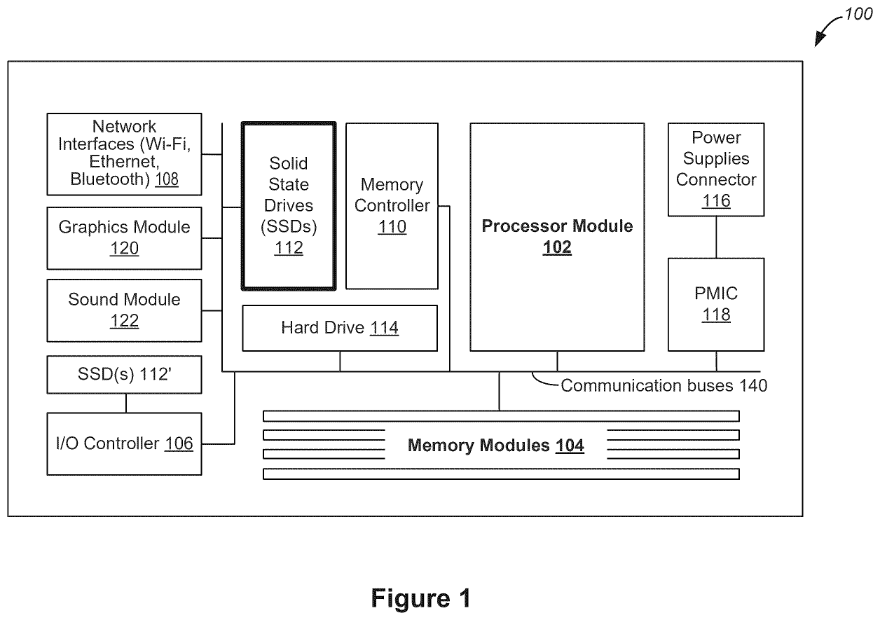

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash memory devices, or other non-volatile solid state storage devices. In some embodiments, the memory modules 104, or alternatively the non-volatile memory device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

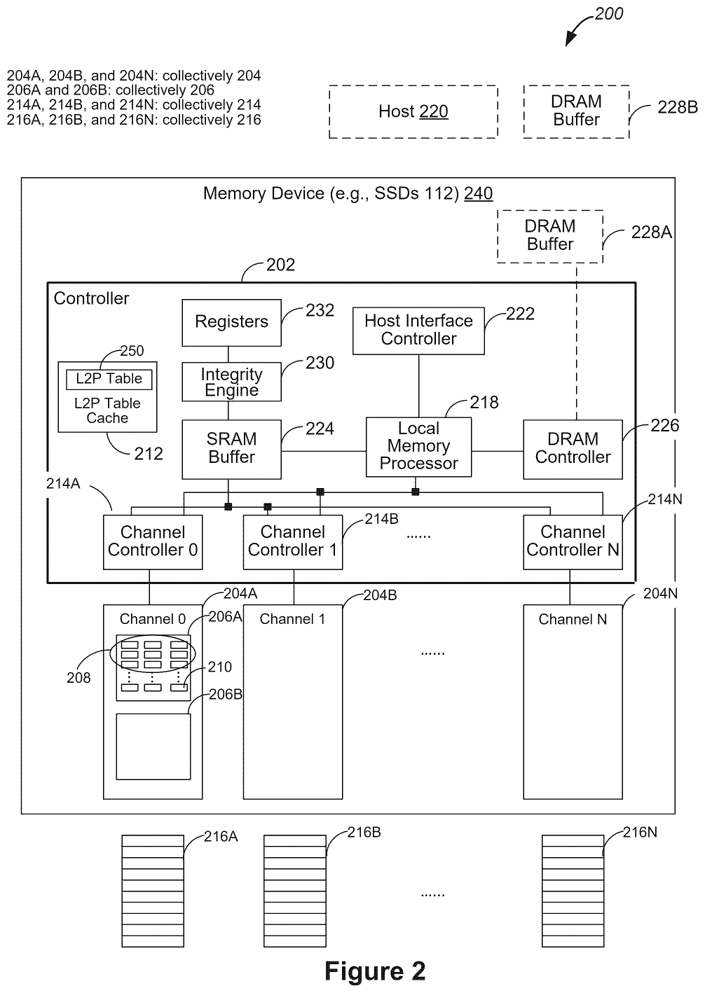

FIG. 2 is a block diagram of a memory system 200 of an example electronic device having one or more memory access queues, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system and execute user applications. The memory system 200 includes one or more memory devices 240 (e.g., SSD(s)). Each memory device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each memory device 240 is formed on a printed circuit board (PCB).

Each memory channel 204 includes on one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, the cache is managed by a host block driver of the host device 220, and called a host managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits. Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing.

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 250 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the memory system 200 includes a DRAM buffer 228A, and the L2P address indirection table 250 is stored in the DRAM buffer 228A. The local memory processor 218 of the controller 202 accesses the DRAM buffer 228A via a DRAM controller 226.

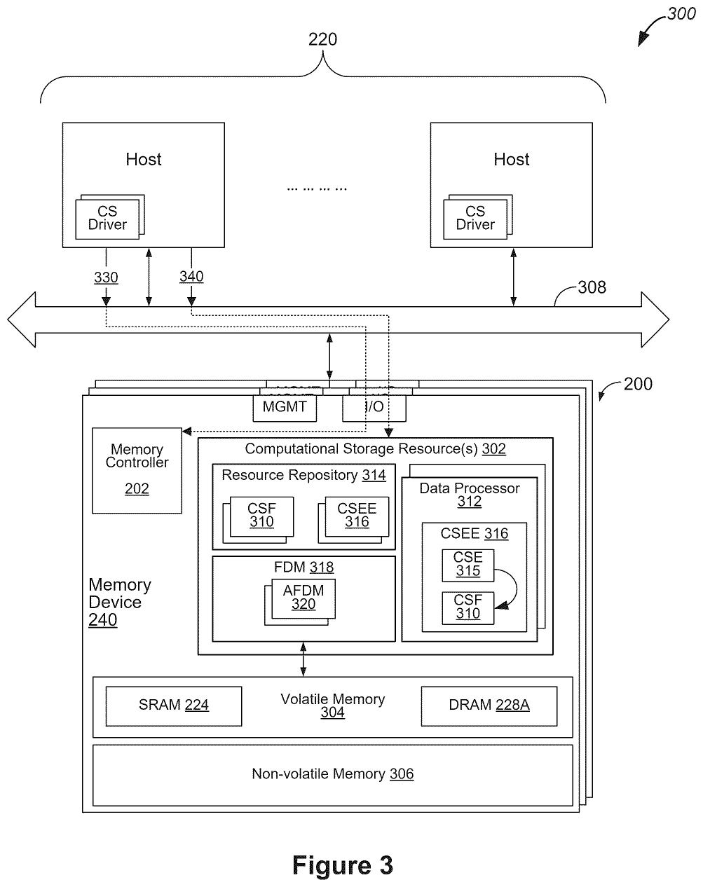

FIG. 3 is a block diagram of an example computer system 300 that includes a memory system 200 having an internal processing capability, in accordance with some embodiments. The memory system 200 is also called a computational storage device (CSD), and includes one or more memory devices 240 (e.g., SSDs). Each memory device 240 further includes a memory controller 202, a volatile memory 304, and a non-volatile memory 306 (e.g., memory channels 204). The host device(s) 220 and the one or more memory devices 240 of the memory system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The volatile memory 304 of each memory device 240 further includes one or more of a L2P table cache 212, a SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the processed data, and intermediate data generated during the data processing operations is temporarily stored in the volatile memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the memory device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the volatile memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 22 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

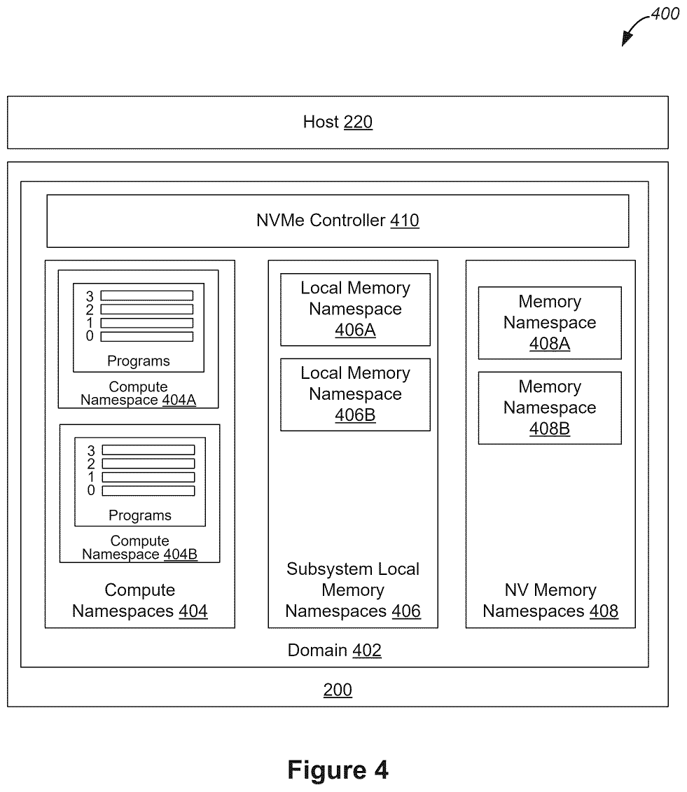

FIG. 4 is a block diagram of an example computer system 400 including a memory system 200 that operates in compliance with a storage access and transport protocol (e.g., nonvolatile memory express (NVMe)), in accordance with some embodiments. The memory system 200 includes one or more memory devices 240 each of which corresponds to a domain 402 according to the storage access and transport protocol. Each domain 402 corresponding to a respective memory device 240 includes a one or more compute namespace 404, local memory namespaces 406, memory namespaces 408, and a domain controller 410. Each namespace is a collection of LBAs accessible to, or associated with, a respective one of the plurality of programs.

A memory device 240 includes one or more processors having a computation capability (e.g., a memory controller 202, a data processor 312), a volatile memory 304 (e.g., a cache 212, a SRAM buffer 224, a DRAM buffer 228A), and a non-volatile memory 306. When the memory device 240 executes a plurality of programs, resources of the memory controller 202, the volatile memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the memory device 240. Resources of the volatile memory 304 are allocated based on a plurality of local memory namespaces 406 (e.g., 406A and 406B) to facilitate execution of the plurality of programs by the memory device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the memory device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the memory device 240 are managed according to the storage access and transport protocol.

In some embodiments, the storage access and transport protocol includes a NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each memory device 240 (e.g., SSD) as a standard NVMe storage device using the NVMe protocol. The host device 220 is configured to read and write data and implement data processing operations on the memory device 240 using NVMe commands.

In some embodiments, the host device 220 uses an operating system (e.g., a Linux operating system), and the CSRs 302 (FIG. 3) of the memory device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the memory device 240.

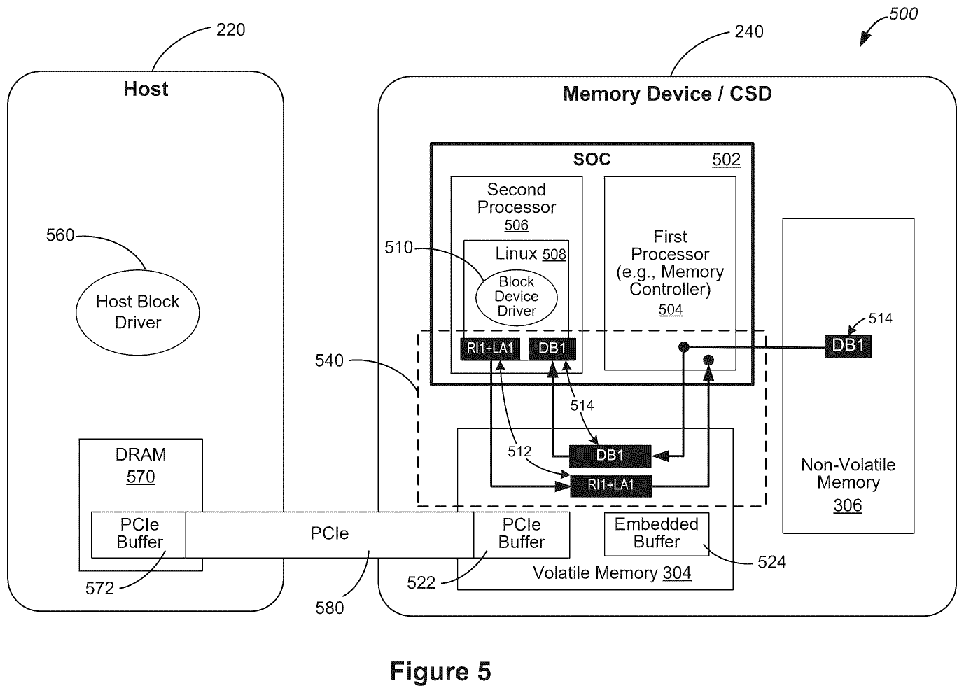

FIG. 5 is a block diagram of an example electronic system 500 including a processor-to-processor interface 540 for reading data block sets (e.g., a first data block set 514) within a memory device 240, in accordance with some embodiments. In some embodiments, the memory device 240 includes a plurality of processors (e.g., a first processor 504, a second processor 506), a volatile memory 304, and a non-volatile memory 306. Further, in some embodiments, a first subset of the plurality of processors is dedicated to processing memory access functions and internal memory management functions, and a second subset of the plurality of processors is configured to implement data processing operations locally on the memory device 240. The memory device 240 is transformed to, and also called, a computational storage device 240, when both memory related functions and data processing operations are integrated in the memory device 240. The processor-to-processor interface 540 acts as an internal interface of the computational storage device 240, thereby allowing data processing to be implemented internally within the computational storage device 240 without running through an external device (e.g., a host device 220).

In some embodiments, the processor-to-processor interface 540 is established based on at least the first processor 504, the second processor 506, and the volatile memory 304. Each of the first processor 504 and the second processor 506 includes a cluster of one or more respective processing cores. The processor-to-processor interface 540 provides a command interface between a computational storage subsystem (e.g., including the second processor 506) and a memory controller subsystem (e.g., the first processor 504), and the command interface is used to copy blocks of stored data (e.g., a first data block set 514 including one or more data blocks) from the non-volatile memory 306 to a subset of volatile memory 304 associated with the computational storage subsystem and copy blocks of data from the subset of volatile memory 304 into the non-volatile memory 306. In some embodiments, each data block corresponds to a minimum data unit size (e.g., a memory page having a size of 4 KB), and a first data block set 514 includes one or more data blocks.

More specifically, in some embodiments, the first processor 504 (e.g., a memory controller 202) extracts a first data block set 514 from the non-volatile memory 306 and stores the first data block set 514 to a subset of volatile memory 304 used as a memory buffer of the second processor 506. The first data block set 514 may be placed in a volatile memory location, in the subset of volatile memory 304, which is specified by the second processor 506. The second memory processor 506 extracts the blocks of stored data from the memory buffer. In some embodiments, the first processor 504 also writes blocks of data from the memory buffer of the second processor 506, and stores the blocks of data to the non-volatile memory 306. The volatile memory 304 is shared by the first processor 504 and the second processor 506. For example, the volatile memory 304 is a Double Data Rate (DDR) memory (e.g., a DRAM buffer 228A). In some embodiments, the non-volatile memory 306 is a NAND flash.

In some embodiments, the computational storage device 240 includes a system-on-chip (SoC) 502 that further includes at least a first processor 504 and a second processor 506. The SoC 502 includes integrated circuits that integrate different computing components (e.g., processors 504 and 506) or other electronic systems (e.g., memories 304 and 306). The second processor 506 is distinct from the first processor 504. In some embodiments, the second processor 506 is configured to execute a device operating system 508 (e.g., an embedded Linux Operating System). The device operating system 508 includes a device kernel (e.g., a Linux kernel) that further includes a block device driver 510. In some embodiments, the first processor 504 is a memory controller 202 (FIG. 2) configured to execute a firmware for memory access functions and internal memory management functions. In some embodiments, each of the first processor 504 and the second processor 506 includes one or more microprocessors (e.g., CPU cores, a cluster of microprocessors, etc.) and/or logic circuits that assist and accelerate queue handling and movement of data.

In some embodiments, the volatile memory 304 includes a device PCIe buffer 522 configured to send or receive PCIe data packets to and from an external device (e.g., an external computer, a server, another distinct computational storage device, etc.). In some embodiments, the volatile memory 304 includes an embedded buffer 524. A first subset of the embedded buffer 524 is allocated to the first processor 504 included in a memory controller subsystem, and acts as a memory buffer of the first processor 504. The second subset of the embedded buffer 524 is allocated to the second processor 506 included in a computational storage subsystem, and acts as a memory buffer of the second processor 506. In some embodiments, the first processor 504 is configured to move data block sets between the first subset and the second subset of the embedded buffer 524 of the volatile memory 304.

In some embodiments, the computational storage device 240 is configured to communicate data with the host device 220 through a PCIe communication interface 580 according to a PCIe interface standard. The PCIe communication interface 580 acts as an external interface between the computational storage device 240 and the host device 220. The host device 220 includes a computer, a server, or other kinds of devices having computational capabilities. In some embodiments, the host device 220 includes a host block driver 560. The host device 220 includes a host memory buffer 570 (e.g., a volatile memory such as a DRAM) that further includes a host PCIe buffer 572. The device PCIe buffer 522 is configured to store PCIe packets that are exchanged with external devices (e.g., other computers, servers, computational storage devices 240, etc.).

In some implementations, the non-volatile memory 306 stores a first data block set 514 including one or more data blocks. To read the first data block set 514 from the non-volatile memory 306, the second processor 506 is configured to generate a first request 512 for the first data block set 514. In an example, the first request 512 includes a first request identifier and a first logical address of the first data block set 514. Further, in some embodiments, the first request 512 includes a destination address of the volatile memory 304 for storing the first data block set 514. The second processor 506 sends the first request 512 to the first processor 504 by way of the processor-to-processor interface 540. Stated another way, the first request 512 may be stored in the embedded buffer 524 from which the first processor extracts and obtains the first request 512. In response to the first request 512, the first processor 504 is configured to extract the first data block set 514 from the non-volatile memory 306 according to the first logical address of the first data block set 514. The first processor 504 is configured to provide the first data block set 514 to the second processor 506 by way of the embedded buffer 524 of the volatile memory 304.

More specifically, in some embodiments, the block device driver 510 of the second processor 506 generates the first request 512 and stores the first request 512 in the volatile memory 304. The first processor 504 extracts the first request 512 from the volatile memory 304. In response to the first request 512, the first processor 504 extracts the first data block set 514 from the non-volatile memory 306 according to the first logical address of the first data block set 514, and stores the first data block set 514 in the volatile memory 304. The first data block set 514 is further extracted from the volatile memory 304 by the block device driver 510 of the second processor 506 for use in the device operating system 508.

In some embodiments, the volatile memory 304 is shared by the first processor 504 and the second processor 506, and is configured to temporarily store the first request 512 and the first data block set 514. For instance, prior to sending the first request 512 to the first processor 504, the block device driver 510 of the second processor 506 temporarily stores the first request 512 in the volatile memory 304. In some embodiments, the first request 512 is temporarily stored in the embedded buffer 524 of the volatile memory 304. In another instance, the first processor stores the first data block set 514 in the volatile memory 304, allowing the block device driver 510 of the second processor 506 to extract the first data block set 514 from the volatile memory 304. In some embodiments, the first data block set 514 is temporarily stored in the embedded buffer 524 of the volatile memory 304.

In some embodiments, after by the first processor 504 extracts the first data block set 514 from the non-volatile memory 306, the first processor 504 implements one or more of: decrypting the first data block set 514 extracted from the non-volatile memory 306, checking a validity of the first data block set 514 based on associated integrity data, and in accordance with detection of a data error, correcting the data error in the first data block set 514. In some embodiments, none of data decryption, data integrity check, data decompression, and data correction for the first data block set 514 is implemented by the first processor 504. In some embodiments, for each different data block set, a subset of data decryption, data integrity check, data decompression, and data correction for the first data block set 514 is dynamically selected and implemented by the first processor 504.

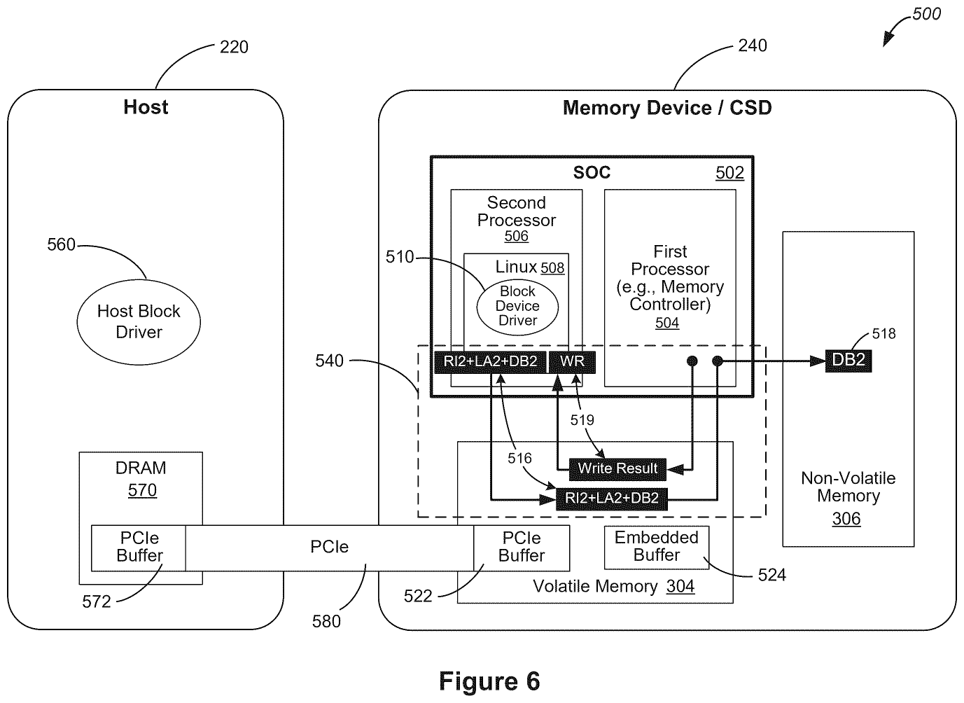

FIG. 6 is a block diagram of another example electronic system 500 including a processor-to-processor interface 540 for writing data block sets (e.g., a second data block set 518) in a memory device 240, in accordance with some embodiments. The memory device 240 is transformed to, and also called, a computational storage device 240 (FIG. 3), when both memory related functions and data processing operations are integrated in the memory device 240. In some embodiments, the computational storage device 240 communicates data externally with the host device 220 through the PCIe communication interface 580 according to the PCIe interface standard. Conversely, in some embodiments, the processor-to-processor interface 540 is used internally in the computational storage device 240 to couple the second processor 506 (e.g., a data processor 312) to the non-volatile memory 306 via the volatile memory 304 and the first processor 504.

In some embodiments, the second processor 506 is configured to generate a second request 516 for storing a second data block set 518 in the non-volatile memory. The second data block set 518 includes one or more second data blocks. In an example, the second request 516 includes a second request identifier and a second logical address of the second data block set 518. Further, in some situations, the second request 516 includes the second data block set 518. In some embodiments, the second request 516 also includes a destination address (e.g., an associated second logical address) of the non-volatile memory 306 for storing the second data block set 518. The second processor 506 sends the second request 516 including the second data block set 518 to the first processor 504, e.g., by way of the volatile memory 304. In response to the second request 516, the first processor 504 stores the second data block set 518 in the non-volatile memory 306 according to the destination address of the second data block set 518. The first processor 504 is further configured to provide a write result 519 (e.g., confirming that a write operation has been completed) to the second processor 506, e.g., by way of the volatile memory 304.

More specifically, in some embodiments the block device driver 510 of the second processor 506 is configured to generate the second request 516 and store the second request 516 in the volatile memory 304, e.g., in a portion of the volatile memory 304 that is specified by the second processor 506. The first processor 504 is configured to extract the second request 516 from the volatile memory 304. In response to the second request 516, the first processor 504 is further configured to store the second data block set 518 in the non-volatile memory 306 according to the destination address of the second data block set 518. The first processor 504 is further configured to store the write result 519 in the volatile memory 304, from which the second processor 506 further extracts the write result 519 for further processing in the device operating system 508. During a write process, the volatile memory 304 is shared by the first processor 504 and the second processor 506 and is configured to temporarily store the second request 516 including the second data block set 518. For instance, the second processor 506 stores the second request 516 in the volatile memory 304, before the first processor 504 extracts from the volatile memory 304, and obtains, the second request 516. Further, in some embodiments, the second request 516 is temporarily stored in the embedded buffer 524 of the volatile memory 304.

In some embodiments, before the first processor 504 stores the second data block set 518 in the non-volatile memory 306, the first processor 504 implements one or both of: encrypting the second data block set 518 provided by the second processor 506 and creating associated integrity data to be stored jointly with the second data block set 518. In some situations, none of data encryption, data integrity protection, and data compression for the second data block set 518 is implemented by the first processor 504. In some embodiments, for each different data block set, a subset of data encryption, data integrity protection, and data compression for the second data block set 518 is dynamically selected and implemented by the first processor 504.

In some embodiments, the computational storage device 240 includes an external interface and an internal interface. The external interface is configured to couple the first processor 504 of the computational storage device 240 to the host device 220. The host device 220 is distinct from the computational storage device 240. The internal interface is configured to couple the first processor 504 to the second processor 506 internally within the computational storage device 240. In an example, the external interface includes a PCIe communication interface 580 for exchanging PCIe data packets between the computational storage device 240 and the host device 220. In some embodiments, the PCIe communication interface 580 is configured to couple to the device PCIe buffer 522 of the volatile memory 304 and the host PCIe buffer 572 of the host memory buffer 570 (e.g., a volatile memory such as a DRAM 228A in FIG. 2). Furthermore, in some embodiments, the internal interface includes a processor-to-processor interface 540 configured to couple the first processor 504 and the second processor 506 via the volatile memory 304. The second processor 506 is configured to read data from, and write data to, the non-volatile memory 306 via the processor-to-processor interface 540 via the volatile memory 304 and the first processor 504.

In some embodiments, the non-volatile memory 306 includes one or more NAND flash chips. In some embodiments, the first processor 504 includes a memory controller 202 (FIG. 2) configured to access and manage data stored in the one or more NAND flash chips of the non-volatile memory 306. In some embodiments, the second processor 506 includes a data processor 312 (FIG. 3) for processing the data stored in the one or more NAND flash chips.

In some embodiments, the processor-to-processor interface 540 acts as an internal interface of the computational storage device 240 and provides a command interface between a memory controller subsystem (including a memory controller 202) and a computational storage subsystem (including a data processor 312). The first processor 504 is configured to copy blocks of stored data from the non-volatile memory 306 to the volatile memory 304 and copy blocks of data from the volatile memory 304 into the non-volatile memory 306. The second processor 506 is configured to obtain blocks of stored data from the volatile memory 304 and provides blocks of data to the volatile memory 304. In other words, the second processor 506 is held from accessing the non-volatile memory 306 directly, and has to access the non-volatile memory 306 indirectly via the processor-to-processor interface 540 (e.g., via the volatile memory 304 and the first processor 504).

In some embodiments, during a write process, the command interface 540 is driven by the second processor 506 to send commands to the first processor 504 and receive command completion results. In some embodiments, the command interface 540 manages pairs of submission and completion queues that are structured as queue entities within an address space of the volatile memory 304, and the address space is accessible to both the first processor 504 and the second processor 506.

In some embodiments, the command interface 540 is configured to comply with NVMe semantics (e.g., NVMe protocols). Example commands implemented by the command interface include, but are not limited to, Ctag (a unique command identifier), Opcode (an operation type identifier), Slba (start logical block addressing (LBA) of the data operation), Numlba (number of LBAs involved in the data operation), Bptr (memory address containing physical region page (PRP) or scatter-gather list (SGL) of data). Examples commands in a completion format include, but are not limited to, Ctag (a unique command identifier) and Rescode (a result code).

In some embodiments, the volatile memory 304 is used by both the first processor 504 and the second processor 506 within the computational storage device 240. The processor-to-processor interface 540 (e.g., the command interface) is configured to create a submission queue and a completion queue for the volatile memory 304. In some embodiments, the processor-to-processor interface 540 is driven by the firmware the first processor 504 and the device operating system 508 of the second processor 506. The volatile memory 304 further includes a first buffer for storing the submission queue and a second buffer for storing the completion queue. In some embodiments, the first and second buffers of the volatile memory 304 are circular buffers, such that each of the submission queue and completion queue is stored in a respective circular buffer. Alternatively, in some embodiments, at least one of the first and second buffers of the volatile memory 304 is distinct from a circular buffer.

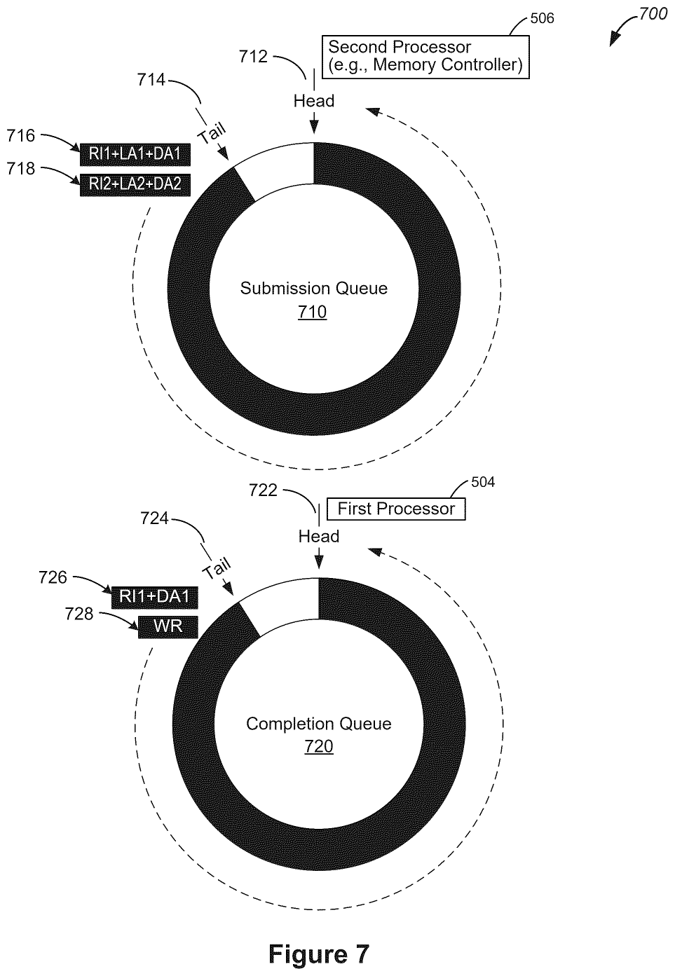

FIG. 7 is a schematic diagram of a storage scheme 700 used in circular buffers of a volatile memory 304, in accordance with some embodiments. Based on the storage scheme 700, the circular buffer includes a first buffer configured to store a submission queue 710 and a second buffer configured to store a completion queue 720. The submission queue 710 has a first head pointer 712 identifying a head of the submission queue 710 and a first tail pointer 714 identifying a tail of the submission queue 710, and the completion queue 720 has a header pointer 722 identifying a second head of the completion queue 720 and a tail pointer 724 identifying a second tail of the completion queue 720. In some embodiments, the submission queue 710 includes a plurality of requests, and the completion queue 720 includes a plurality of data packets. A number of the plurality of requests equal to a number of the plurality of data packets. In some embodiments, the second processor 506 is a multi-core processor and includes a plurality of processor cores having a second number of processing cores. The processor-to-processor interface 540 is configured to create a plurality of submission queues 710 having a first number of submission queues 710. Each submission queue is assigned to a respective processor core. The second number is equal to the first number.

In some embodiments, the second processor 506 generates, and sends to the first processor 504, a first request 716 for reading the first data block set 514 (FIG. 5) from the non-volatile memory 306. The first request 716 is added to the tail of the submission queue 710 stored in the first buffer of the volatile memory 304. The first request 716 includes a first request identifier and a first destination address (e.g., a first logical address) of the first data block set 514. The first tail pointer 714 corresponds to the tail of the submission queue 710, and is updated to identify a memory location corresponding to an end of the first request 716, after the first request 716 is stored in the submission queue 710. As requests, which are stored in the submission queue 710 before the first request, are processed by the first processor 504, the first request 716 gradually moves to the head of the submission queue 710 until it is processed by the first processor 504. After the first processor 504 reads the first request 512 from the head of the submission queue 710, the first head pointer 712 is updated to point to a memory location corresponding to a start of a next request following the first request 716 in the submission queue.

In some embodiments, the first processor 504 provides the first data block set 514 extracted from the non-volatile memory 306 to the second processor 506 by adding a first data packet 726 to a second tail of the completion queue 720. The second tail pointer 724 corresponds to the tail of the completion queue 720, and is updated to identify a memory location corresponding to an end of the first data packet 726. As data packets stored in the completion queue 720 before the first data packet 726 are read by the second processor 506, the first data packet 726 gradually moves to the head of the completion queue 720 until it is read by the second processor 506. The second head pointer 722 corresponds to the head of the completion queue 720, and is updated to point to a memory location corresponding to a start of a next data packet following the first data packet 726 in the completion queue 720.

In some embodiments, the second processor 506 submits a second request 718 for writing a second data block set 518 (FIG. 6) to the non-volatile memory 306, and add the second request 718 to the tail of the submission queue 710. The second request 718 includes the second request identifier and a second destination address (e.g., a second logical address) of the second data block set 518. Further, in some embodiments, the second request 718 includes the second data block set 518. The first tail pointer 714 corresponds to the tail of the submission queue 710, and is updated to identify a memory location corresponding to an end of the second request 718, after the second request 718 is stored in the submission queue 710. As requests, which are stored in the submission queue 710 before the second request 718, are processed by the first processor 504, the second request 718 gradually moves to the head of the submission queue 710 until it is processed by the first processor 504. The first processor 504 reads the first request 512 from the head of the submission queue 710 and generates a write result 519 (FIG. 6), and the first head pointer 712 is updated to point to a memory location corresponding to a start of a next request following the second request 718 in the submission queue 710.

In some embodiments, the first processor 504 provides the write result 519 to the second processor 506, and adds a second data packet 728 including the write result 519 to the tail of the completion queue 720. The second tail pointer 724 corresponds to the tail of the completion queue 720, and is updated to identify a memory location corresponding to an end of the second data packet 728. As data packets stored in the completion queue 720 before the second data packet 728 are read by the second processor 506, the second data packet 728 gradually moves to the head of the completion queue 720 until it is read by the second processor 506. The second head pointer 722 corresponds to the head of the completion queue 720, and is updated to point to a memory location corresponding to a start of a next data packet following the second data packet 728 in the completion queue 720.

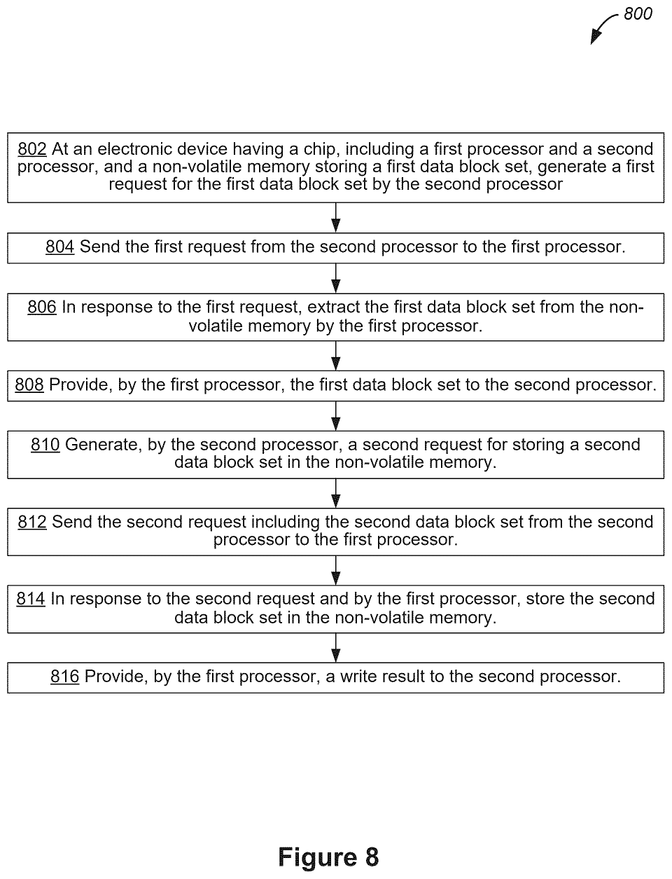

FIG. 8 is a flow diagram of an example method 800 of processing data on a memory device 240 (also called a computational storage device 240), in accordance with some embodiments. Specifically, the flow diagram of Figure 800 is implemented at an electronic device that includes a computational storage device described above in reference to FIGS. 1-7. The method of 800 includes, at an electronic device having a chip, including a first processor and a second processor, and a non-volatile memory storing a first data block set, generating (operation 802) a first request for the first data block set by the second processor. The method of 800 further includes sending (operation 804) the first request from the second processor to the first processor. The method of 800 further includes in response to the first request, extracting (operation 806) the first data block set from the non-volatile memory by the first processor. The method of 800 further includes providing (operation 808), by the first processor, the first data block set to the second processor.

In some embodiments, the method of 800 further includes generating (operation 810), by the second processor, a second request for storing a second data block set in the non-volatile memory. The method of 800 further includes sending (operation 812) the second request including the second data block set from the second processor to the first processor. The method of 800 further includes in response to the second request and by the first processor, storing (operation 814) the second data block set in the non-volatile memory. The method of 800 further includes providing (operation 816), by the first processor, a write result to the second processor.

In some embodiments, the electronic device further includes a volatile memory shared by the first processor and second processor. The method of 800 further includes temporarily storing the first request and the first data block set in the volatile memory.

In some embodiments, the electronic device further includes a volatile memory. Sending the first request from the second processor to the first processor further includes storing by the second processor the first request in the volatile memory, and extracting by the first processor the first request from the volatile memory.

In some embodiments, the electronic device further includes a volatile memory. Providing, by the first processor, the first data block set to the second processor further includes storing by the first processor the first data block set in the volatile memory, e.g., in a portion of the volatile memory specified by the second processor, and extracting by the second processor the first data block set from the volatile memory.

In some embodiments, the electronic device further includes a volatile memory shared by the first processor and second processor. The method of 800 further includes creating a submission queue and a completion queue for the volatile memory. Each of the submission queue and the completion queue is stored in a respective circular buffer.

In some embodiments, the method of 800 further includes, by the second processor, adding the first request into a tail of the submission queue. The first request includes a first request identifier and a first logical address of the first data block set. The method of 800 further includes, by the second processor, updating a first tail pointer corresponding to the tail of the submission queue. The method of 800 further includes, by the second processor, reading the first data block set from a head of the completion queue. The method of 800 further includes, by the second processor, updating a second head pointer corresponding to the head of the completion queue.

In some embodiments, the method of 800 further includes, by the first processor, reading the first request from a head of the submission queue. The method of 800 further includes, by the first processor. The method of 800 further includes, by the first processor, updating a first head pointer corresponding to the head of the submission queue. The method of 800 further includes, by the first processor, adding a first data packet including a first request identifier and a first destination address into a tail of the completion queue. The method of 800 further includes, by the first processor, updating a second tail pointer corresponding to the tail of the completion queue.

In some embodiments, the second processor includes a plurality of processor cores. The method of 800 further includes creating a plurality of submission queues. A second number of the plurality of processor cores equal to a first number of the plurality of submission queues.

In some embodiments, the electronic device further includes an external interface and an internal interface. The external interface is configured to couple the first processor to a host device distinct from the electronic device. The internal interface is configured to couple the first processor to the second processor internally.

In some embodiments, the method of 800 further includes, after by the first processor extracting the first data block set from the non-volatile memory, implementing by the first processor one or more of: decrypting the first data block set extracted from the non-volatile memory, checking a validity of the first data block set based on associated integrity data, and in accordance with detection of a data error, correcting the data error in the first data block set.

In some embodiments, the electronic device further includes a volatile memory shared by the first processor and second processor. The method of 800 further includes temporarily storing the second request including the second data block set in the volatile memory.

In some embodiments the electronic device further includes a volatile memory. Sending the second request from the second processor to the first processor further includes storing by the second processor the second request including the second data block set in the volatile memory, e.g., in a portion of the volatile memory 304 that is specified by the second processor 506, and extracting by the first processor the second request from the volatile memory.

In some embodiments, the electronic device further includes a volatile memory. Providing, by the first processor, a write result to the second processor further includes storing by the first processor the write result in the volatile memory, and extracting by the second processor the write result from the volatile memory.

In some embodiments, the electronic device further includes a volatile memory shared by the first processor and second processor. The volatile memory has a first circular buffer for storing a submission queue and a second circular buffer for storing a completion queue.

In some embodiments, the method of 800 further includes, by the second processor, adding a subset of the second request into a tail of the submission queue, the second request further including a second request identifier and a second logical address of the second data block set. The method of 800 further includes, by the second processor, updating a first tail pointer corresponding to the tail of the submission queue. The method of 800 further includes, by the second processor, reading the write result from a head of the completion queue. The method of 800 further includes, by the second processor, updating a second head pointer corresponding to the head of the completion queue.

In some embodiments, the method of 800 further includes, by the first processor, reading a subset of the second request from a head of the submission queue. The method of 800 further includes, by the first processor, updating a first head pointer corresponding to the head of the submission queue. The method of 800 further includes, by the first processor, adding the write result into a tail of the completion queue. The method of 800 further includes, by the first processor, updating a second tail pointer corresponding to the tail of the completion queue.

In some embodiments, the method of 800 further includes, before the first processor stores the second data block set in the non-volatile memory, implementing by the first processor one or both of: encrypting the second data block set provided by the second processor and creating associated integrity data to be stored jointly with the second data block set.

In some embodiments, the method of 800 further includes implementing an operating system on the second processor. A kernel of the operating system includes a block device driver. The first request is generated by the block device driver.

In some embodiments, the non-volatile memory includes one or more NAND flash chips. The first processor includes a memory controller configured to access and manage data stored in the one or more NAND flash chips. The second processor includes a processor for processing the data stored in the one or more NAND flash chips.

In accordance with some embodiments, a memory device includes a non-volatile memory and a chip. The non-volatile memory is configured to store a first data block set. The chip is configured to couple to the non-volatile memory and includes a first processor and a second processor. The chip is configured to perform any of the methods described in the above embodiments.

In accordance with some embodiments, a memory system includes a host device and a memory device coupled to the host device. The memory device further includes a non-volatile memory and a chip. The non-volatile memory is configured to store a first data block set. The chip is configured to couple to the non-volatile memory and includes a first processor and a second processor. The chip is configured to perform any of the methods described in the above embodiments.

In accordance with some embodiments, a non-transitory computer-readable storage medium stores instructions, which when executed by a memory system cause the memory system to perform any of the methods described in the above embodiments.

It should be understood that the particular order in which the operations in FIG. 8 have been described are merely exemplary and are not intended to indicate that the described order is the only order in which the operations could be performed. One of ordinary skill in the art would recognize various ways to providing computational storage devices as described herein. It is also noted that more details on the method of providing computational storage devices are explained above with reference to FIGS. 1-7. For brevity, these details are not repeated in the description herein.

Memory is also used to store instructions and data associated with the method of 800, and includes high-speed random-access memory, such as SRAM, DDR DRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing the method of 800. Alternatively, in some embodiments, the electronic device implements the method of 800 at least partially based on an ASIC. The electronic device includes a computational storage device, an SSD in a data center, or a client device.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,”depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

1. A method for processing data, comprising:
at a storage device having a chip, including a first processor and a second processor, and a non-volatile memory storing a first data block set, wherein the first processor includes a memory controller configured to access and manage data stored in the non-volatile memory:
generating a first request for the first data block set by the second processor;
sending the first request from the second processor to the first processor; and
in response to the first request, extracting the first data block set from the non-volatile memory by the first processor; and
providing, by the first processor, the first data block set to the second processor.

2. The method of claim 1, wherein the storage device further includes a volatile memory shared by the first processor and second processor, the method further comprising:
temporarily storing the first request and the first data block set internally in the volatile memory of the storage device.

3. The method of claim 1, wherein the storage device further includes a volatile memory, and sending the first request from the second processor to the first processor further comprises:
storing by the second processor the first request in the volatile memory; and
extracting by the first processor the first request from the volatile memory.

4. The method of claim 1, wherein the storage device further includes a volatile memory, and providing, by the first processor, the first data block set to the second processor further comprises:
storing by the first processor the first data block set in a portion of the volatile memory specified by the second processor; and
extracting by the second processor the first data block set from the portion of the volatile memory.

5. The method of claim 1, wherein the storage device further includes a volatile memory shared by the first processor and second processor, the method further comprising:
creating a submission queue and a completion queue for the volatile memory, wherein each of the submission queue and the completion queue is stored in a respective circular buffer.

6. The method of claim 5, further comprising, by the second processor:
adding the first request into a tail of the submission queue, the first request including a first request identifier and a first logical address of the first data block set;
updating a first tail pointer corresponding to the tail of the submission queue;
reading the first data block set from a head of the completion queue; and
updating a second head pointer corresponding to the head of the completion queue.

7. The method of claim 5, further comprising, by the first processor:
reading the first request from a head of the submission queue;
updating a first head pointer corresponding to the head of the submission queue;
adding a first data packet including a first request identifier and a first destination address into a tail of the completion queue; and
updating a second tail pointer corresponding to the tail of the completion queue.

8. The method of claim 5, wherein the second processor includes a plurality of processor cores, the method further comprising:
creating a plurality of submission queues, a second number of the plurality of processor cores equal to a first number of the plurality of submission queues.

9. The method of claim 1, wherein:
the storage device further includes an external interface and an internal interface;
the external interface is configured to couple the first processor to a host device distinct from the storage device; and
the internal interface is configured to couple the first processor to the second processor internally.

10. The method of claim 1, further comprising, after by the first processor extracting the first data block set from the non-volatile memory, implementing by the first processor one or more of:
decrypting the first data block set extracted from the non-volatile memory;
checking a validity of the first data block set based on associated integrity data; and
in accordance with detection of a data error, correcting the data error in the first data block set.

11. A memory device, comprising:
a non-volatile memory for storing a first data block set;
a chip coupled to the non-volatile memory and including a first processor and a second processor, wherein the first processor includes a memory controller configured to access and manage data stored in the non-volatile memory, and the chip is configured to implement instructions for:
generating a first request for the first data block set by the second processor;
sending the first request from the second processor to the first processor; and
in response to the first request, extracting the first data block set from the non-volatile memory by the first processor; and
providing, by the first processor, the first data block set to the second processor.

12. The memory device of claim 11, wherein the chip is further configured to implement instructions for:
generating, by the second processor, a second request for storing a second data block set in the non-volatile memory;
sending the second request including the second data block set from the second processor to the first processor;
in response to the second request and by the first processor, storing the second data block set in the non-volatile memory; and
providing, by the first processor, a write result to the second processor.

13. The memory device of claim 12, wherein the memory device further includes a volatile memory shared by the first processor and second processor, and the chip is further configured to implement instructions for temporarily storing the second request including the second data block set internally in the volatile memory of the memory device.

14. The memory device of claim 12, wherein the memory device further includes a volatile memory, and sending the second request from the second processor to the first processor further comprises:
storing by the second processor the second request including the second data block set in a portion of the volatile memory specified by the second processor; and
extracting by the first processor the second request from the portion the volatile memory.

15. The memory device of claim 12, further comprising a volatile memory, wherein providing, by the first processor, a write result to the second processor further comprising:
storing by the first processor the write result in the volatile memory; and
extracting by the second processor the write result from the volatile memory.

16. The memory device of claim 12, further comprising a volatile memory shared by the first processor and second processor, and the volatile memory has a first circular buffer for storing a submission queue and a second circular buffer for storing a completion queue.

17. The memory device of claim 12, wherein the chip is further configured to implement instructions for: before by the first processor storing the second data block set in the non-volatile memory, implementing by the first processor one or both of:
encrypting the second data block set provided by the second processor; and
creating associated integrity data to be stored jointly with the second data block set.

18. A non-transitory computer-readable storage medium, having instructions stored thereon, which when executed by a memory device cause the memory device to perform operations comprising:
at the memory device, wherein the memory device has a chip including a first processor and a second processor, and a non-volatile memory storing a first data block set. and the first processor includes a memory controller configured to access and manage data stored in the non-volatile memory:
generating a first request for the first data block set by the second processor;
sending the first request from the second processor to the first processor; and
in response to the first request, extracting the first data block set from the non-volatile memory by the first processor; and
providing, by the first processor, the first data block set to the second processor.

19. The non-transitory computer-readable storage medium of claim 18, wherein the operations further comprise:
implementing an operating system on the second processor, wherein a kernel of the operating system includes a block device driver, wherein the first request is generated by the block device driver.

20. The non-transitory computer-readable storage medium of claim 18, wherein the non-volatile memory includes one or more NAND flash chips, and wherein the second processor includes a data processor for processing the data stored in the one or more NAND flash chips.
